(19) United States
(12) Patent Application Publication
(10) Pub. No.: US 2020/0378544 A1
(43) Pub. Date: Dec. 3, 2020

(54) VACUUM INSULATION PANEL ARRANGEMENT

(71) Applicant: VA-Q-TEC AG, Würzburg (DE)

(72) Inventors: Tobias BOCK, Biebelried OT Kaltensondheim (DE); Ivo NEMETZ, Gelnhausen (DE); Joachim KUHN, Würzburg (DE)

(21) Appl. No.: 16/636,254

(22) PCT Filed: Aug. 7, 2018
(86) PCT No.: PCT/EP2018/071392

§ 371 Date: Feb. 3, 2020

(30) Foreign Application Priority Data
Aug. 7, 2017 (DE) 20 2017 004 137.5

(51) Int. Cl. F16L 59/065; B60R 13/08; A47C 7/18; B32B 5/02; B32B 5/18; B32B 5/24; B32B 27/12

(52) U.S. Cl. CPC F16L 59/065; B60R 13/0815; A47C 7/185; B32B 5/024; A47C 7/40; B32B 5/18; B32B 5/245; B32B 27/12; B32B 5/026

(57) ABSTRACT

The invention relates to a vacuum insulation panel arrangement on a vacuum insulation panel having two mutually opposite outer faces and edges that connect these outer faces, and having a protective layer that surrounds the vacuum insulation panel tightly on all sides. The invention is characterized in that, in order to form the protective layer, the vacuum insulation panel is coated entirely with flexible synthetic foam.

The invention relates to a vacuum insulation panel arrangement with a vacuum insulation panel with two outer surfaces lying opposite one another and edges joining these outer surfaces and with a protective layer surrounding the vacuum insulation panel on all sides in a closely fitting manner.

A vacuum insulation panel is a thermal insulation element which is normally plate-like. This is known in various embodiments (DE 10 2010 019 074 A1). The manner in which the vacuum insulation panel is constructed is fundamentally unimportant for the present invention.

A vacuum insulation panel generally has a base body composed of an open-pore material which endows the vacuum insulation panel with the required mechanical stability. The open-pore nature of said material ensures sufficient evacuability of the base body. This base body is enclosed in a closely fitting manner by a gas-tight film. The interior space formed by the film and filled by the base body is evacuated. As a result, the desired thermal insulation properties of the vacuum insulation panel are achieved. In detail, reference is also made in this regard to DE 20 2014 008 767 U1, the content of disclosure of which is also of significance for the present vacuum insulation panel arrangement.

The known vacuum insulation panel arrangement on which the invention is based (DE 20 2014 008 767 U1) has firstly an adhesively attached protective film composed of PVC which protects against mechanical impact by sharp-edged tools and secondly, to complete the protective film composed of PVC, an elastically cushioning protective layer composed of flexible plastic foam, in particular composed of cellular rubber.

The known vacuum insulation panel arrangements are used for the thermal insulation of machines and installations, for example for the thermal insulation of storage containers. The protective layer composed of flexible plastic foam, in particular composed of cellular rubber, and located on an outer surface of the vacuum insulation panel is suitable, for example, for compensating unevennesses of a surface against which the vacuum insulation panel is pressed.

Generally known from practice are seat cushions and backrest cushions that attendees at a sporting event, for example, take with them to make the hard wooden folding seat in the stadium somewhat more comfortable. These customary seat cushions or backrest cushions consist entirely of flexible plastic foam, in particular of flexible PVC foam. The cushioning action thereof is often good but the thermal insulation often leaves much to be desired.

A seat cushion or backrest cushion of the type known from practice is typically arranged in a closely fitting outer casing composed of a woven fabric or knitted fabric that can be exchanged and, in the case of soiling, can be washed. The outer casing is normally open on one edge and closed there by a zip fastener.

Also known individually are articles of clothing or parts of articles of clothing, e.g. back protectors or shin guards, that combine a certain stiffness with a cushioning action and as a result protect the body against impacts or the like in correspondingly relevant areas.

Finally, cushioning interior fittings or fixtures for implementing impact protection in vehicles are known.

The invention is based on the object of specifying a vacuum insulation panel arrangement having improved properties, in particular for applications as a seat cushion or a backrest cushion or for other suitable applications.

The problem presented above is solved in the case of a vacuum insulation panel arrangement having the features of claim 1.

According to the invention, the vacuum insulation panel itself is thus completely encapsulated in a flexible plastic foam. A layer composed of the desired flexible plastic foam is located on all outer surfaces and edges.

A seat pad or backrest pad designed in this way not only has an excellent cushioning action, as the seat pads or backrest pads known from the prior art also do, but also has an excellent thermal insulation action on account of the vacuum insulation panel intimately embedded in the flexible plastic foam.

Preferred refinements and developments are the subject matter of the dependent claims.

The invention also relates to a seat cushion or backrest cushion with a corresponding vacuum insulation panel arrangement, or to a corresponding seat shell of the backrest shell, in which case the vacuum insulation panel arrangement has a vacuum insulation panel which is curved as a whole and embedded in the protective layer composed of flexible plastic foam.

The invention also relates to articles of clothing or parts of articles of clothing with a corresponding vacuum insulation panel arrangement for protecting the individual wearing the article of clothing or the part of the article of clothing in a corresponding area.

Finally, the invention also relates to cushioning interior fittings or fixtures for implementing impact protection in vehicles, insofar as they have a corresponding vacuum insulation panel arrangement.

The invention will now be explained in more detail below on the basis of a drawing which merely illustrates one preferred exemplary embodiment. In the drawing:

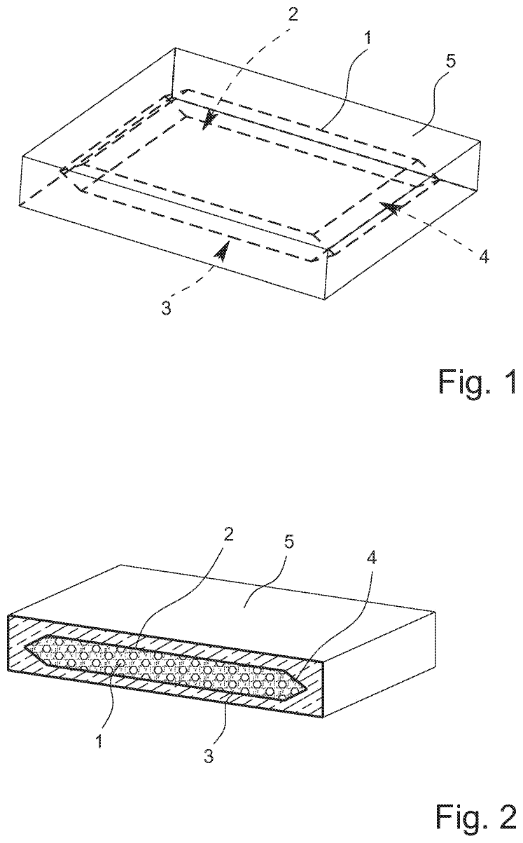

FIG. 1 shows a perspective view of a vacuum insulation panel arrangement according to the invention,

FIG. 2 shows a cross section through the vacuum insulation panel arrangement from FIG. 1 and

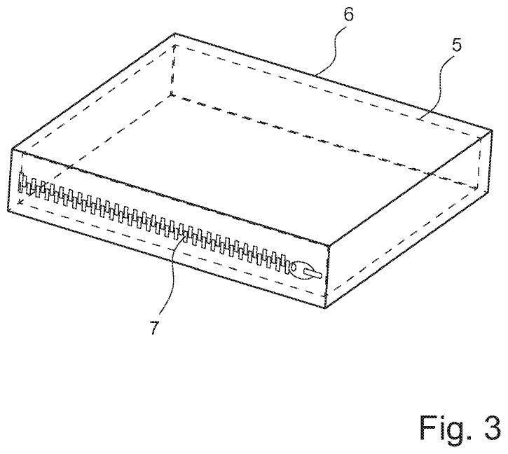

FIG. 3 shows a vacuum insulation panel arrangement according to FIG. 1 inside an outer casing.

FIGS. 1 and 2 show the basic principle of the invention, specifically a vacuum insulation panel arrangement with a vacuum insulation panel 1 with two outer surfaces 2, 3 lying opposite one another and edges 4 joining these outer surfaces 2, 3 and with a protective layer 5 surrounding the vacuum insulation panel 1 on all sides in a closely fitting manner. Here, provision is made for the vacuum insulation panel 1 to be completely encapsulated in a flexible plastic foam to form the protective layer 5. The continuous protective layer 5 which is on all sides and composed of flexible plastic foam forming a complete foamed encapsulation can be seen especially clearly in FIG. 2.

It can be clearly seen in FIG. 1 that the vacuum insulation panel arrangement is plate-like and can be used as a type of seat cushion. It can also be used, preferably in slightly curved form, as a type of backrest cushion. It is important that a very good thermal insulation action is achieved by the vacuum insulation panel 1 in the vacuum insulation panel arrangement and that at the same time, a very good cushioning action is achieved by the protective layer 5 composed of flexible plastic foam.

Data relating to vacuum insulation panels of the type in question can be found, for example, in the starting document DE 20 2014 008 767 U1, and also relating to the prior art cited therein. Data relating to the flexible plastic foam to be used for the protective layer 5 can be found, for example, in Wikipedia under the heading “Foam rubber” or on the website “Spektrum” in the “Lexikon der Chemie” [Chemistry dictionary] under “Schaumkunststoffe” [Foamed plastics].

With respect to selecting the flexible plastic foam of the protective layer 5, it is recommended that said foam has a density between 10 and 150 kg/m³, preferably between 30 and 100 kg/m³.

The above-described foam density for which preferred ranges have been specified has nothing to do with the question of whether it is a relatively strong or less strong flexible plastic foam. A relatively dense flexible plastic foam does not have to be a very strong flexible plastic foam, and vice versa. For the cushioning action, the foam density is less important than the so-called indentation hardness or compressive strength. Compressive strength or compression resistance is the pressure (measured in kPa) required to compress a sample body to 40% of its original thickness by means of a defined penetration body. A compressive strength of 50 corresponds to a pressure of 5.0 kPa. Details are specified in DIN 53577.

For the flexible plastic foam according to the invention, a compressive strength between 0.5 and 8.0, preferably between 1.5 and 6.0, is recommended in accordance with preferred teaching.

In the case of the vacuum insulation panel arrangement according to the invention, preferred materials for the flexible plastic foam are polystyrene foam, cellular rubber, for example EPDM, flexible PVC foam, polyethylene foam or, in particular, flexible polyurethane foam.

A particularly preferred exemplary embodiment is a flexible plastic foam, configured as flexible polyurethane or polyethylene foam.

For a normal application, preferably as a seat cushion, it is recommended that, without loading, the protective layer 5 has a thickness of 3 mm to 25 mm, preferably of 10 mm to 15 mm, on the outer surfaces 2, 3 and has a thickness of 5 mm to 50 mm, preferably of 20 mm to 40 mm, on the edges 4.

As regards the thickness of the vacuum insulation panel 1 itself, a thickness between 5 mm and 15 mm, in particular for the present preferred usage situation, is thus recommended. In principle, other dimensions are naturally conceivable if other usage situations are intended.

In the case of the vacuum insulation panel arrangement according to the invention, it is finally recommended to provide for the vacuum insulation panel 1 with the protective layer 5 to be arranged in a closely fitting, exchangeable outer casing 6 composed of a woven fabric, a knitted fabric or a film. FIG. 3 shows such a configuration. At the front, on the outer casing 6, a zip fastener 7 for closing can be found. After opening the zip fastener 7, the outer casing 6 may be pulled off from the protective layer 5 and washed, for example, should it have been soiled.

The invention also relates to a seat cushion or backrest cushion, configured as a vacuum insulation panel arrangement as claimed in one of claims 1 to 7.

The invention further also relates to a seat shell or backrest shell, configured as a suitably curved vacuum insulation panel arrangement as claimed in one of claims 1 to 7.

The invention finally also relates to an article of clothing or a part of an article of clothing with a vacuum insulation panel arrangement as claimed in one of claims 1 to 7.

The invention also relates to a cushioning interior fitting or fixture for a motor vehicle body, having a vacuum insulation panel arrangement as claimed in one of claims 1 to 7.

### LIST OF REFERENCE SIGNS

1 Vacuum insulation panel
2 Outer surface
3 Outer surface
4 Edges
5 Protective layer
6 Outer casing
7 Zip fastener

1. A vacuum insulation panel arrangement
on a vacuum insulation panel with two outer surfaces lying opposite one another and edges joining these outer surfaces and
with a protective layer surrounding the vacuum insulation panel on all sides in a closely fitting manner,
wherein
the vacuum insulation panel is completely encapsulated in a flexible plastic foam to form the protective layer.

2. The vacuum insulation panel arrangement as claimed in claim 1, wherein
the flexible plastic foam of the protective layer has a density between 10 and 150 kg/m3.

3. The vacuum insulation panel arrangement as claimed in claim 1, wherein
the flexible plastic foam of the protective layer has an indentation hardness (compressive strength) between 0.5-8.0.

4. The vacuum insulation panel arrangement as claimed in claim 1, wherein
the protective layer consists of a polystyrene foam, a cellular rubber, EPDM, a flexible PVC foam, a polyethylene foam or a flexible polyurethane foam.

5. The vacuum insulation panel arrangement as claimed in claim 1, wherein
without loading, the protective layer
has a thickness of 3 mm to 25 mm on the outer surfaces and
has a thickness of 5 mm to 50 mm on the edges.

6. The vacuum insulation panel arrangement as claimed in claim 1, wherein
the vacuum insulation panel itself has a thickness of 5 mm to 15 mm.

7. The vacuum insulation panel arrangement as claimed in claim 1, wherein
the vacuum insulation panel with the protective layer is arranged in a closely fitting, exchangeable outer casing composed of a woven fabric, a knitted fabric or a film.

8. A seat cushion or backrest cushion, configured as a vacuum insulation panel arrangement as claimed in claim 1.

9. A seat shell or backrest shell, configured as a suitably curved vacuum insulation panel arrangement as claimed in claim 1.

10. An article of clothing or parts of an article of clothing having a vacuum insulation panel arrangement as claimed in claim 1.

11. A cushioning interior fitting or fixture for a motor vehicle body, having a vacuum insulation panel arrangement as claimed in claim 1.
